(19) United States
(12) Patent Application Publication
(10) Pub. No.: US 2025/0365067 A1
(43) Pub. Date: Nov. 27, 2025

(54) METHOD FOR EVALUATING ROUTING RESILIENCE OF A SATELLITE NETWORK

(71) Applicant: BEIJING UNIVERSITY OF POSTS AND TELECOMMUNICATIONS, Beijing (CN)

(72) Inventors: Jiaxin Zhang, Beijing (CN); Wenbo Wang, Beijing (CN); Chang Liu, Beijing (CN)

(21) Appl. No.: 19/173,525

(22) Filed: Apr. 8, 2025

(30) Foreign Application Priority Data
May 27, 2024 (CN) 202410664523.X

(51) Int. Cl. H04B 7/185; H04B 7/195

(52) U.S. Cl. CPC H04B 7/18584; H04B 7/195

(57) ABSTRACT

The present disclosure provides a method for evaluating routing resilience of a satellite network, including: step 1: determining a fully-connected topology graph of the satellite network, determining a routing policy and a proportional parameter; step 2: calculating a first routing efficiency of the fully-connected topology graph; step 3: calculating a second routing efficiency of a damaged network and a variation rate of routing efficiency; step 4:determining a collapse threshold; step 5: calculating a resilience value; step 6: resetting the proportional parameter to 0, and repeating step 3, step 4, and step 5; step 7: calculating an average collapse threshold; step 8: calculating an average resilience value.

### CROSS REFERENCE

This disclosure claims priority to Chinese Patent Application No. 202410664523.X, entitled “Resilience Efficiency Evaluation Method for Satellite Internet Routing” filed on May 27, 2024, which is incorporated by reference in its entirety.

### TECHNICAL FIELD

This disclosure relates to the field of satellite communication technology, and in particular to a method for evaluating routing resilience of a satellite network.

### BACKGROUND

With continuous increase of Low Earth Orbit (LEO) satellites, user demands are becoming more diverse and complex. These growing demands place higher requirements on satellite system performance, including accuracy, reliability and stability of data transmission. Therefore, a satellite network, e.g., a satellite Internet, may become more resilient to address the increasing diversity and complexity of the user requirements.

In practical applications, evaluating the resilience of a satellite Internet with high reliability has become a key issue. Destruction resistance represents the ability of the satellite Internet to maintain its original network connectivity under varying levels of attack. The definition of destruction resilience also includes the ability to restore the continuity of network data transmission after attack. Therefore, the physical significance of destruction resilience lies not only in the satellite network's ability to resist destruction, but also in its adaptability and survivability in a constantly changing environment.

In related arts, a graph theory is used to examine the impact of node or link destruction on the network connectivity. However, it does not consider routing mechanism and the reliability of data transmission in the satellite network. Currently, the network resilience is calculated by measuring destruction resistance metrics, but it cannot evaluate the gap between its resilience and a theoretical limit under a specific routing method. And it also fails to predict an extent to which a proportion of failed network edges would lead to significant degradation in routing reliability. Therefore, the routing control scheme for the satellite network is not optimal.

In addition, indicators for evaluating the destruction resilience may be categorized into two types: global metrics and local metrics. Global metrics may measure the overall topology, but may not consider the impact of satellite nodes and links, so that the uniqueness of individual nodes may not be fully explored. Local metrics may indicate the destructive capability of individual nodes, but it may not comprehensively evaluate the overall performance of the satellite network.

Therefore, current methods cannot meet the multi-mission requirements of satellite networks.

### SUMMARY

According to one or more embodiments, a method for evaluating routing resilience of a satellite network is provided, including:
step 1: determining a fully-connected topology graph of the satellite network, determining a routing policy for the satellite network and a proportional parameter ƒ indicating a ratio of failure edges over all edges in the fully-connected topology graph; initializing the proportional parameter ƒ being 0, and a number of iterations beginning from 1;
step 2: calculating a first routing path length between any two nodes in the fully-connected topology graph according to the routing policy, and calculating a first routing efficiency Eₚᵣₑ of the fully-connected topology graph according to the first routing path length;
step 3: for the nₜₕ iteration, disconnecting ƒ-proportional of edges in the fully-connected topology graph to obtain a damaged network, calculating a second routing path length between any two nodes in a topology graph of the damaged network according to the routing policy, calculating a second routing efficiency

$${E}_{f}^{n}$$

of the damaged network according to the second routing path length, calculating a variation rate of routing efficiency qⁿ(ƒ) according to the first routing efficiency Eₚᵣₑ and the second routing efficiency

$${E}_{f}^{n} ,$$

n being an integer; increasing a value of ƒ with a predetermined increment and repeating step 3 until ƒ reaches 100%, to determine a set of variation rates of routing efficiency {qⁿ(0), . . . , qⁿ(100%)};
step 4: for the nₜₕ iteration, determining a value of ƒ which results in a size of the second-largest connected subgraph being a maximum, as a collapse threshold

$${f}_{th}^{n} ;$$

step 5: for the nₜₕ iteration, fitting a resilience function Qⁿ(ƒ) using the set of variation rates of routing efficiency {qⁿ(0), . . . , qⁿ(100%)}, and calculating a resilience value Rusing the resilience function Qⁿ(ƒ);
step 6: if n does not reach a preset maximum iterations N, increasing n by 1 and resetting ƒ to 0, and repeating step 3, step 4, and step 5;
step 7: if n reaches the preset maximum iterations N, calculating an average collapse threshold ƒₜₕ^{a} according to the collapse threshold ƒₜₕⁿ calculated in step 4 from the 1^{st} iteration to the final Nₜₕ iteration; and
step 8: calculating an average resilience value Ra according to the resilience value Rⁿ calculated in step 5 from the 1^{st} iteration to the final Nₜₕ iteration.
According to one or more embodiments, a non-transitory computer-readable storage medium is provided. The non-transitory computer-readable storage medium storing a computer program causing a computer to execute the above method for evaluating routing resilience of a satellite network.

### BRIEF DESCRIPTION OF THE DRAWINGS

FIG. 1 is a schematic diagram of a method for evaluating routing resilience of a satellite network according to an embodiment of this disclosure.

FIG. 2 is a schematic diagram of an ecological resilience theory.

FIG. 3 is a schematic diagram of connected subgraphs according to an embodiment of this disclosure.

FIG. 4 is a schematic diagram illustrating performance according to an embodiment of this disclosure.

FIG. 5 is a schematic diagram illustrating performance according to an embodiment of this disclosure.

FIG. 6 is a schematic diagram illustrating performance according to an embodiment of this disclosure.

### DESCRIPTION OF EMBODIMENTS

The following will provide a clear and complete description of the technical solutions in the embodiments of this disclosure, in conjunction with the accompanying drawings. It is evident that the described embodiments represent only a portion of the embodiments of this disclosure, and not all possible embodiments. All other embodiments derived by those skilled in the art without requiring inventive efforts, based on the embodiments provided in this disclosure, are within the scope of protection of this disclosure.

In embodiments of this disclosure, a first routing efficiency of a fully-connected satellite network may be determined by routing path lengths among all satellite nodes in the fully-connected satellite network. The transmission paths may be determined by a routing mechanism input into the satellite network.

Specifically, the first routing efficiency is defined as a ratio of a sum of reciprocals of the routing path lengths between all node pairs to the total number of node pairs, given by

$${E}_{p r e} = \frac{1}{M ( M - 1 )} {\sum }_{i \neq j ∈ V} \frac{1}{{d}_{i j}^{p r e}} \qquad ( 1 )$$

wherein V indicates a set of satellite nodes in the satellite network, M represents a total number of satellite nodes in V, a node i and a node j are two different modes in V, and

$${d}_{i j}^{p r e}$$

represents a first routing path length between the node i and the node j.

In embodiments of this disclosure, a second routing efficiency of a damaged network with ƒ-proportional edges failing is defined as a reciprocal of an average routing path length among all node pairs after removing ƒ-proportional edges from the whole satellite network. The calculation is given by

$${E}_{f} = \frac{1}{M ( M - 1 )} {\sum }_{i \neq j ∈ V} \frac{1}{{d}_{i j}^{f}} \qquad ( 2 )$$

wherein E_{ƒ} denotes the second routing efficiency, and

$${d}_{i j}^{f}$$

represents a second routing pain length between a node i and a node j after removing ƒ-proportional of edges from the whole satellite network.

In embodiments of this disclosure, the first routing efficiency and the second routing efficiency both refer to the global network efficiency.

In embodiments of this disclosure, a variation rate of routing efficiency is defined as a ratio of the first routing efficiency to the second routing efficiency, given by:

$$q ( f ) = {E}_{f} / {E}_{p r e} \qquad ( 3 )$$

wherein q(ƒ) represents the variation rate. The value of q(ƒ) represents the ability of the satellite network to maintain its original network resilience, and a maximum value of q(ƒ) is 1.

In embodiments of this disclosure, to establish a resilience model for a satellite network, a number of connected subgraphs, a size of each connected subgraph, and a link transmission efficiency of the satellite network are considered to calculate both a collapse threshold and the variation rate of routing efficiency. Accordingly, a resilience function for routing in the satellite network may be evaluated.

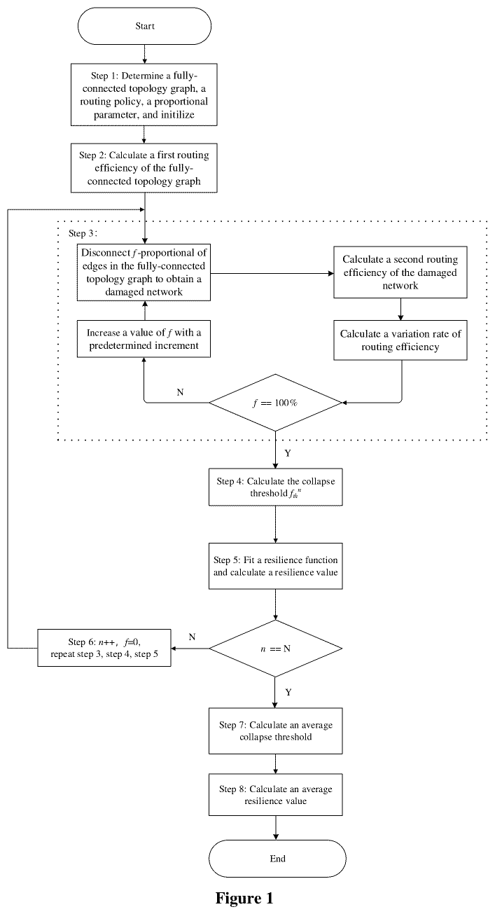

According to embodiments of this disclosure, the resilience model provides a basis for enhancing routing reliability of the satellite network. The specific steps for evaluating routing resilience of a satellite network are shown in FIG. 1, including the following steps.

Step 1: Determine a fully-connected topology graph of a satellite network, the fully-connected topology graph being an initial topology graph of the satellite network with no node or link being damaged. Determine a routing policy for the satellite network and a proportional parameter ƒ indicating a ratio of failure edges over all edges in the fully-connected topology graph. Initialize the proportional parameter ƒ being 0, and a number of iterations begins from 1.

According to an example of the embodiments, the fully-connected topology graph may be generated by a virtual topology method, in which, all the nodes are connected with each other.

Step 2: Calculate a first routing path length between any two nodes in the fully-connected topology graph, according to the routing policy. Then, calculate a first routing efficiency Eₚᵣₑ according to the first routing path length based on (1).

Step 3: For the nₜₕ iteration, disconnect ƒ-proportional of edges in the fully-connected topology graph to obtain a damaged network, and split a topology graph of the damaged network into a plurality of connected subgraphs. Then, calculate a size of a largest connected subgraph and a size of a second-largest connected subgraph of the damaged network, where the size of a subgraph is defined as the number of nodes in the subgraph. Calculate a second routing efficiency

$${E}_{f}^{n}$$

or the damaged network with ƒ-proportional edges failing, according to (2). Calculate a variation rate of routing efficiency qⁿ(ƒ) according to (3), where n is an integer. And increase the value of ƒ with a predetermined increment and repeat Step 3 until ƒ reaches 100%, to determine a set of variation rates of routing efficiency {qⁿ(0), . . . , qⁿ(100%)}.

In this step, the disconnected ƒ-proportional of edges may be randomly selected from the fully-connected topology graph based on the value of ƒ. For each value of ƒ, the topology of the damaged network is changed.

In this step, a second routing path length between any two nodes in a topology graph of the damaged network is calculated according to the routing policy, and the second routing efficiency

$${E}_{f}^{n}$$

of the damaged network is calculated according to the second routing path length based on (2).

Step 4: For the nₜₕ iteration, determine a value of ƒ which results in a size of the second-largest connected subgraph being a maximum, as a collapse threshold

$${f}_{th}^{n} .$$

The fragmentation and saturation of the satellite network may significantly reduce the transmission efficiency of the satellite network, slow down the on-board task processing, and potentially lead to the satellite network's collapse.

Step 5: For the nₜₕ iteration, fit a resilience function Qⁿ(ƒ) using the set of variation rates of routing efficiency {qⁿ(0), . . . , qⁿ(100%)}. A resilience value Rⁿ is calculated using the resilience function Qⁿ(ƒ) through integration by:

$${R}^{n} = {\int }_{0}^{{f}_{t h}^{n}} {Q}^{n} ( f ) d f = {\int }_{0}^{{f}_{t h}^{n}} ( {E}_{f}^{n} / {E}_{p r e} ) d f \qquad ( 4 )$$

Step 6: If the current number of iterations n does not reach a preset maximum iterations N, increase n by 1 and reset ƒ to 0. Then, repeat step 3, step 4, and step 5.

Step 7: If the current number of iterations n reaches the preset maximum iterations N, calculate and output an average collapse threshold

$${f}_{th}^{a} ,$$

representing an average of all the collapse thresholds

$${f}_{th}^{n}$$

calculated in step 4 from the 1^{st} iteration to the final Nₜₕ iteration. The calculation is given by:

$${f}_{th}^{a} = \frac{{f}_{t h}^{1} + … + {f}_{t h}^{N}}{N} \qquad ( 5 )$$

When ƒ equals the collapse threshold

$${f}_{th}^{a} ,$$

the satellite network reaches the critical point of a sudden drop in resilience.

Step 8: Calculate and output an average resilience value R^{a}, representing an average of all resilience values Rⁿ calculated in step 5 from the 1^{st} iteration to the final Nₜₕ iteration. The calculation is given by:

$${R}^{a} = \frac{{R}^{1} + … + {R}^{N}}{N} \qquad ( 6 )$$

And the range of R^{a} varies between 0 and 1. When the satellite network is most resilient, the value of q(ƒ) tends to 1, ƒ tends to 100%, and R^{a} tends to 1.

According to an ecological resilience theory, when a system is subjected to an uncertain perturbation, key variables of the system may change, so that the system's ability to maintain its basic functions may be affected. Once these key variables exceed a specific threshold, the system will enter a new state and cannot be able to continue to maintain its original functions.

Therefore, the resilience level of the system depends on its state space needed to maintain its original functions, i.e., a size of an attraction domain. The size of the attraction domain is determined by a specific threshold for the state variation of the satellite network changes and a state variation function of the satellite network.

When the state space required for the system to maintain its original functions becomes larger, the attraction domain will increase accordingly. Thus, the resilience level of the system may also be improved, so that the system is more capable to cope with external perturbations and changes while maintaining its original functions stable.

Based on the above, embodiments of this disclosure provide a framework for evaluating and managing the stability and adaptability of such networks. The resilience level of the system can be evaluated more accurately by observing and analyzing its state space and the thresholds of key variables.

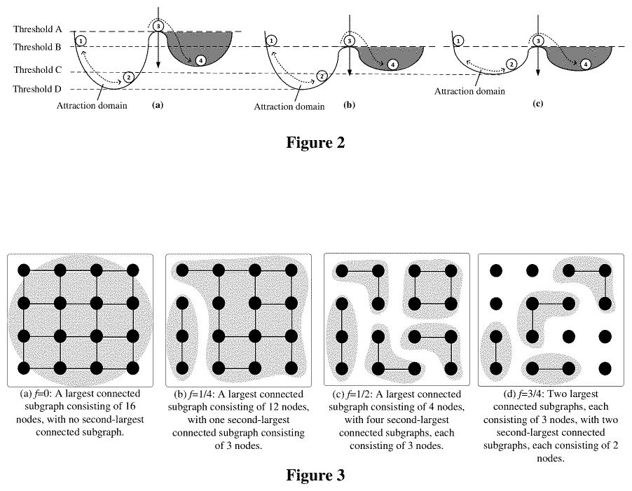

FIG. 2 illustrates a schematic diagram of an ecological resilience theory. As shown in FIG. 2, four state thresholds are configured, i.e., threshold A, threshold B, threshold C, threshold D. A ball is released freely from a position 1 and moves along the trajectories, as illustrated by arrows in FIGS. 2(a), 2(b), and 2(c). A white area and a grey area represent two different system states. And the white area makes up an attraction domain. If the ball aims to preserve its original state, it cannot reach position 3. The attraction domain in FIG. 2(b) is larger than that in FIG. 2(c). Therefore, the ball is less likely to change its state in FIG. 2(b). Hence, when the state space required for the ball to maintain its original basic state is larger, the attraction domain is larger, and the system's resilience level is higher.

In a satellite network, the network topology may be determined by effective connections among all nodes. The number of the connected subgraphs and a size of each connected subgraph may reflect the connectivity status of the satellite network and affect its resilience. If several inter-satellite links (ISLs) fail, the entire satellite network may be divided into multiple connected subgraphs with varying sizes. As the proportion of failed edges in the satellite network increases, the load of the satellite network may increase gradually. As a result, the size of the largest connected subgraph may be reduced gradually.

Simultaneously, as the proportion of failed edges in the satellite network increases to an extent, a second-largest connected subgraph may arise. As the proportion of failed edges increases, the second-largest connected subgraph continues to be segmented, the number of the resultant connected subgraphs becomes larger, and the size of the second-largest connected subgraph may not increase without any limit. These connected subgraphs may also impact the state of the satellite network, and cause the load of the nodes to increase.

Hence, the fragmentation and saturation of the satellite network may greatly reduce the transmission efficiency, slow down task processing on the satellite network, and potentially lead to network collapse.

In the system design, the collapse threshold is used for analyzing the resilience efficiency of satellite networks to proactively address potential network collapses. As shown in FIG. 3, where ƒ denotes the proportion of failed edges versus all edges. It can be seen that, as ƒ increases, the size of the second-largest connected subgraph tends to increase to 3 (see FIG. 3(b), FIG. 3(c)) and then decrease to 2 (see FIG. 3(d)). When ƒ reaches 3/4,the number of connected subgraphs increases to 10 as shown in FIG. 3(d), which is twice the number of connected subgraphs, i.e., 5 as shown in FIG. 3(c), when ƒ is ½.

Additionally, when ƒ reaches ¾, the size of the second-largest connected subgraph is 2 as shown in FIG. 3(d), which is smaller than the size being 3 as shown in FIG. 3(c) when the proportion of failed edges is ½. Therefore, a collapse threshold can be identified within the interval of the proportion from ½ to ¾. The collapse threshold indicates an abrupt change of the resilience capability of the satellite network, which causes the satellite network's performance to degrade rapidly.

In an embodiment, a LEO satellite network is deployed, which includes 100 LEO satellites, forming a Walker Delta constellation, evenly distributed across 10 orbital planes with a phase factor of 3, an orbital inclination of 55 degrees, and an altitude of 508 kilometers.

Under the above constellation, two ways of establishing links are implemented to compare the network resilience metrics and collapse thresholds.

The first way of establishing links: each LEO satellite has two types of ISLs: an intra-orbit Inter-Satellite Link (iISL) and an inter-orbit Inter-Satellite Link (sISL).

The second way of establishing links: each LEO satellite has three types of ISLs: an iISL, an sISL, and an encountering Inter-Satellite Link (eISL). The eISL refers to a link between two encountering satellites respectively on an ascending orbit and on a descending orbit.

Assuming that the Earth is a sphere, a maximum Euclidean distance between two mutually-visible LEO satellites is given by:

$$d i {s}_{v} = 2 \sqrt{{( {R}_{E} + h )}^{2} - {R}^{2}} \qquad ( 7 )$$

wherein R_{E} represents the Earth's radius, and h indicates an orbital altitude of the LEO satellite.

To avoid excessive energy consumption during ISL establishment caused by an excessive number of eISLs, a maximal inter-satellite distance and a minimal inter-satellite distance are introduced.

Based on positions of a node i and a node j in a Cartesian coordinate system, the maximal inter-satellite distance may be calculated by the following equation:

$$d i {s}_{max} = d i {s}_{v} \times ( 1 - \vert \frac{\vec{{e}_{z}} ( {\vec{r}}_{i} + {\vec{r}}_{j} )}{2 {R}_{E}} \vert ) \qquad ( 8 )$$

wherein \vec{e_{z}} denotes a unit vector of the z-axis, \vec{r}ᵢ and \vec{r}ⱼ represent direction vectors of the node i and the node j, respectively. When the nodes are located at high latitudes, the value

$$\vert \frac{\vec{{e}_{z}} ( {\vec{r}}_{i} + {\vec{r}}_{j} )}{2 {R}_{E}} \vert$$

increases and disₘₐₓ decreases accordingly.

In order to increase the speed of establishing links and routing reliability, the minimal inter-satellite distance may be determined as a minimum of hops between a pair of encountering nodes.

In an example, an inter-satellite topological distance between encountering satellites or nodes is defined, denoted as

$$d i {s}_{i , j}^{topo} ,$$

which may be calculated as a maximum value of the difference between the orbit identities (IDs) and the difference between the satellite IDs, given by:

$$d i {s}_{i , j}^{topo} = max ( Δ p , Δ f ) \qquad ( 9 )$$

wherein Δp denotes the difference between an orbital ID of the encountering node i and an orbital ID of the encountering node j, given by

$$Δ p = \{ \begin{matrix}\begin{matrix}\begin{matrix}\vert {Orbit}_{i} - {Orbit}_{j} \vert & \vert {Orbit}_{i} - {Orbit}_{j} \vert \leq \frac{{N}_{p}}{2}\end{matrix} & \end{matrix} \\ \begin{matrix}min ( {Orbit}_{i} , {Orbit}_{j} ) + {N}_{p} - max ( {Orbit}_{i} , {Orbit}_{j} ) & else\end{matrix}\end{matrix} \qquad ( 10 )$$

wherein Orbitᵢ denotes the orbit ID of the orbit in which the encountering node i is located, Orbitⱼ denotes the orbit ID of the orbit in which the node j is located, Nₚ denotes a total number of orbits;
Δƒ represents the difference between a satellite ID of the encountering node i and a satellite ID of the encountering node j, given by

$$Δ f = \begin{matrix}\{ \begin{matrix}\begin{matrix}\begin{matrix}\vert {Satmum}_{i} - {Satmum}_{j} \vert & \vert {Satmum}_{i} - {Satmum}_{j} \vert \leq \frac{{N}_{s}}{2}\end{matrix} & \end{matrix} \\ \begin{matrix}min ( {Satmum}_{i} , {Satmum}_{j} ) + {N}_{s} - max ( {Satmum}_{i} , {Satmum}_{j} ) & else\end{matrix}\end{matrix} & ( 11 )\end{matrix}$$

wherein Satmumᵢ denotes the satellite ID of the encountering node i in Orbitᵢ, Satmumⱼ denotes the satellite ID of the encountering node j in Orbitⱼ, Nₛ denotes the number of satellites in each orbit.

As a requirement to establish eISLs, the inter-satellite distance between encountering nodes dis_{i,j} may be less than disₘₐₓ, and the inter-satellite topological distance between encountering nodes

$$d i {s}_{i , j}^{topo}$$

may be greater than disₘᵢₙ, as given by:

$$\{ \begin{matrix}d i {s}_{i , j} \leq d i {s}_{max} \\ d i {s}_{i , j}^{topo} \geq d i {s}_{min}\end{matrix} \qquad ( 12 )$$

In an example, disₘᵢₙ may be set to 1.

In an embodiment, a ƒ-proportion of failed edges are removed in the fully-connected topology graph of the satellite network, to obtain a damaged network. The topology graph of the damaged network is split into a plurality of connected subgraphs, and a size of each connected subgraph is calculated using a depth-first search algorithm. Based on the size, the largest connected subgraph with a largest size and the second-largest connected subgraph with a second-largest size are determined.

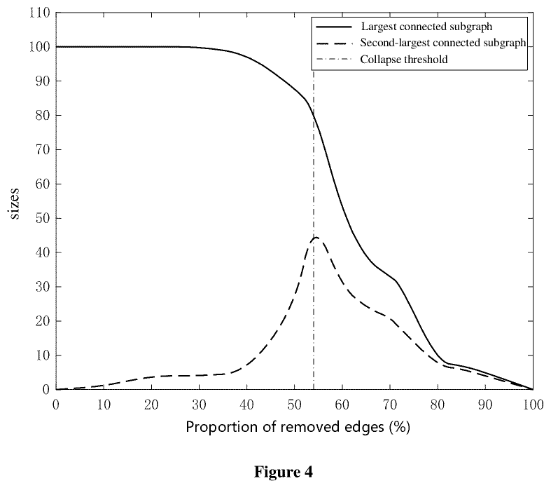

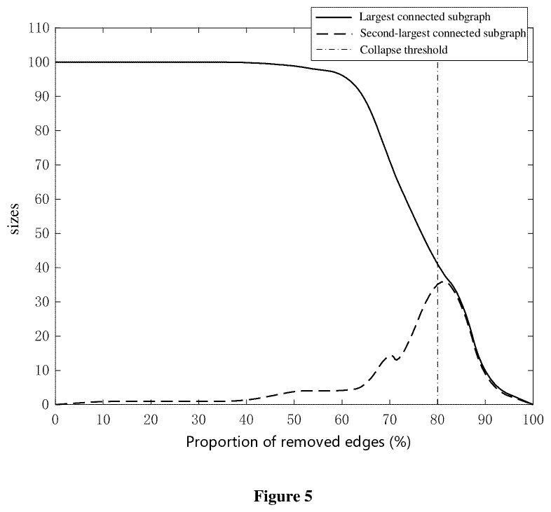

FIG. 4 and FIG. 5 show the sizes of the largest connected subgraph and the second-largest connected subgraphs, and the collapse threshold based on the first way of establishing links and the second way of establishing links, respectively.

It can be seen that, as the proportion of removed edges, i.e., the value of ƒ, increases, the sizes of the largest connected subgraphs initially remain stable and then gradually decrease, while the sizes of the second-largest connected subgraphs gradually increase at first and then decrease. The collapse threshold of this satellite network is approximately 53% (as shown in an x-axis of FIG. 4) for the first way of establishing links and approximately 80% (as shown in an x-axis of FIG. 5) for the second way of establishing links.

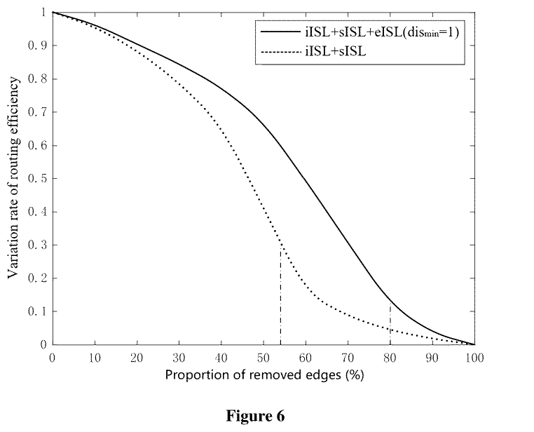

In addition, the variation rate of routing efficiency of the satellite network is calculated according to Eq. (3). The routing path length is calculated using the shortest path algorithm. For example, the shortest path algorithm may be a Dijkstra's algorithm. As shown in FIG. 6, a plot of the variation rate of routing efficiency for the two ways of establishing links is presented, wherein the second way of establishing links is denoted as “iISL+sISL+eISL (disₘᵢₙ=1)”, and the first way of establishing links is denoted as “iISL+sISL”.

Based on data in FIG. 6, the resilience values of this satellite network are calculated, according to (6), to be 0.42 and 0.54, respectively for the first way of establishing links and the second way of establishing links. It can be seen that, the resilience value under the second way of establishing links is approximately 28.6% higher than that of the first way of establishing links. This is because the routing hops and the distance (calculated based on the shortest path algorithm) between a source satellite and a destination satellite can be reduced by adding more eISLs, and the resilience of the LEO satellite network may increase at the same time.

According to embodiments in this disclosure, the reliability of data transmission of a satellite Internet is enhanced, and the impact of routing control strategies on the capability of network resilience is evaluated. The embodiments can measure the limit of resilience capability of the satellite network under a given network topology and a routing control scheme. The methods described above may be applied to a satellite Internet with any network topology and routing control scheme. The method described above may comprehensively consider factors such as network connectivity and data transmission efficiency, determine the collapse threshold that the satellite network may encounter under a current routing control scheme, and effectively evaluate the global resilience capacity limit of the satellite Internet.

The specific embodiments presented in this document explain the principles and implementation methods of the present invention. The description of the above embodiments is only intended to aid in understanding the methods and core concepts of the present invention and is not meant to limit this disclosure. Those skilled in the art may make changes to the specific implementation methods and application scope based on the ideas, spirit, and principles of the present invention. Any modifications, equivalent substitutions, improvements, and the like made should fall within the scope of protection of this disclosure.

What is claimed is:

1. A method for evaluating routing resilience of a satellite network, comprising:
step 1: determining a fully-connected topology graph of the satellite network, determining a routing policy for the satellite network and a proportional parameter ƒ indicating a ratio of failure edges over all edges in the fully-connected topology graph;
initializing the proportional parameter ƒ being 0, and a number of iterations beginning from 1;
step 2: calculating a first routing path length between any two nodes in the fully-connected topology graph according to the routing policy, and calculating a first routing efficiency Eₚᵣₑ of the fully-connected topology graph according to the first routing path length;
step 3: for the nₜₕ iteration, disconnecting ƒ-proportional of edges in the fully-connected topology graph to obtain a damaged network, calculating a second routing path length between any two nodes in a topology graph of the damaged network according to the routing policy, calculating a second routing efficiency
$${E}_{f}^{n}$$
of the damaged network according to the second routing path length, calculating a variation rate of routing efficiency qⁿ(ƒ) according to the first routing efficiency Eₚᵣₑ and the second routing efficiency
$${E}_{f}^{n} ,$$
n being an ineger; increasing a value of ƒ with a predetermined increment and repeating step 3 until ƒ reaches 100%, to determine a set of variation rates of routing efficiency {qⁿ(0), . . . , qⁿ(100%)};
step 4: for the nₜₕ iteration, determining a value of ƒ which results in a size of the second-largest connected subgraph being a maximum, as a collapse threshold
$${f}_{th}^{n} ;$$
step 5: for the nₜₕ iteration, fitting a resilience function Qⁿ(ƒ) using the set of variation rates of routing efficiency {qⁿ(0), . . . , qⁿ(100%)}, and calculating a resilience value Rⁿ using the resilience function Qⁿ(ƒ);
step 6: if n does not reach a preset maximum iterations N, increasing n by 1 and resetting ƒ to 0, and repeating step 3, step 4, and step 5;
step 7: if n reaches the preset maximum iterations N, calculating an average collapse threshold
$${f}_{th}^{a}$$
according to the collapse threshold
$${f}_{th}^{n}$$
calculated in step 4 from the 1^{st} iteration to the final Nth iteration; and
step 8: calculating an average resilience value R^{a} according to the resilience value Rⁿ calculated in step 5 from the 1^{st} iteration to the final Nₜₕ iteration.

2. The method of claim 1, wherein in step 2, the first routing efficiency Eₚᵣₑ is calculated by:
$${E}_{pre} = \frac{1}{M ( M - 1 )} {\sum }_{i \neq j ∈ V} \frac{1}{{d}_{ij}^{pre}}$$
wherein V indicates a set of satellite nodes in the satellite network, M represents a total number of satellite nodes in V, a node i and a node j are two different nodes in V, and
$${d}_{ij}^{pre}$$
represents the first routing path length between the node i and the node j.

3. The method of claim 2, wherein in step 3, the second routing efficiency
$${E}_{f}^{n}$$
is calculated by:
$${E}_{f}^{n} = \frac{1}{M ( M - 1 )} {\sum }_{i \neq j ∈ V} \frac{1}{{d}_{ij}^{f , n}}$$
wherein
$${d}_{ij}^{f , n}$$
represents the second routing path length between the node i and the node j after removing ƒ-proportional of edges in the nₜₕ interation.

4. The method of claim 3, wherein in step 3, the variation rate of routing efficiency qⁿ(ƒ) is calculated by:
$${q}^{n} ( f ) = {E}_{f}^{n} / {E}_{pre}$$
wherein a value of qⁿ(ƒ) represents ability of the satellite network to maintain its original network resilience, and a maximum value of qⁿ(ƒ) is 1.

5. The method of claim 1, wherein in step 5, when ƒ equals to the collapse threshold
$${f}_{th}^{n} ,$$
the resilience value Rⁿ is calculated by:
$${R}^{n} = {\int }_{0}^{{f}_{th}^{n}} {Q}^{n} ( f ) df .$$

6. The method of claim 1, wherein in step 7, the average collapse threshold
$${f}_{th}^{a}$$
is calculated by:
$${f}_{th}^{a} = \frac{{f}_{th}^{1} + … + {f}_{th}^{N}}{N} .$$

7. The method of claim 6, wherein in step 8, the average resilience value R^{a} is calculated by:
$${R}^{a} = \frac{{R}^{1} + … + {R}^{N}}{N} .$$

8. The method of claim 1, wherein the fully-connected topology graph is an initial topology graph of the satellite network with no node or link being damaged.
